(19) United States
(12) Patent Application Publication
(10) Pub. No.: US 2025/0292130 A1
(43) Pub. Date: Sep. 18, 2025

(54) APPARATUS AND METHOD FOR SIMULATING LOGICAL QUBIT

(71) Applicant: Electronics and Telecommunications Research Institute, Daejeon (KR)

(72) Inventors: Soo-Cheol OH, Daejeon (KR); Young-Chul KIM, Daejeon (KR); Chei-Yol KIM, Sejong-si (KR); Jin-Ho ON, Sejong-si (KR); Sang-Min LEE, Daejeon (KR); Eun-Young CHO, Daejeon (KR); Ki-Sung JIN, Iksan-si (KR); Gyu-II CHA, Daejeon (KR)

(73) Assignee: Electronics and Telecommunications Research Institute, Daejeon (KR)

(21) Appl. No.: 18/970,112

(22) Filed: Dec. 5, 2024

(30) Foreign Application Priority Data
Mar. 18, 2024 (KR) 10-2024-0037333

(51) Int. Cl. G06N 10/20

(52) U.S. Cl. CPC G06N 10/20

(57) ABSTRACT

Disclosed herein is an apparatus and method for simulating a logical qubit. The apparatus receives a logical qubit operation for simulating a logical qubit, performs a logical qubit operation for calculating a logical value, a probability amplitude, and the number of state vectors using a logical qubit behavior model, and stores the result of the logical qubit operation for the logical value, the probability amplitude, and the number of state vectors.

### CROSS REFERENCE TO RELATED APPLICATION

This application claims the benefit of Korean Patent Application No. 10-2024-0037333, filed Mar. 18, 2024, which is hereby incorporated by reference in its entirety into this application.

### BACKGROUND OF THE INVENTION

### 1. Technical Field

The present disclosure relates generally to quantum computing technology, and more particularly to logical qubit simulation technology.

### 2. Description of the Related Art

A quantum computer is a computer that processes data using quantum mechanical phenomena such as entanglement, superposition, and the like. Quantum computers are regarded as next-generation computers capable of replacing semiconductor computers. However, technology research related to quantum computers has fallen short of realizing quantum computers.

Quantum computers are being actively researched by various companies. The recent quantum computers are in the early stages of development at the level of supporting about 50 qubits with errors and have not been put to practical use.

The most basic operation in a rotated surface code is error syndrome measurement that is used to correct qubit errors by generating error syndromes. The error syndrome measurement is also used to perform logical qubit initialization and a logical quantum operation based on lattice surgery. Therefore, in order to simulate a logical qubit based on the rotated surface code, it is necessary to imitate an error syndrome measurement operation. However, the error syndrome measurement, which is a basic operation of a logical qubit, is performed through a complex physical qubit operation of O(d²), which depends on the distance (d) of a logical qubit, so the complexity of execution increases rapidly as d increases, which makes the simulation impossible.

If supercomputers are used, current quantum simulators are able to simulate up to 49 qubits. In the current quantum simulators, the distance of 5 or less can be simulated in the rotated surface code.

Meanwhile, U.S. Pat. No. 11,699,002, titled “Separable-state simulation of quantum program code”, relates to a method for digitally simulate a quantum state of a qubit and discloses a method for representing the amplitudes of complex members for quantum states as an array and changing the same depending on circuit execution.

### SUMMARY OF THE INVENTION

An object of the present disclosure is to enable simulation of logical qubit operations of all distances, which cannot be performed in existing quantum simulators.

Another object of the present disclosure is to provide a faster performance time than existing quantum simulators.

In order to accomplish the above objects, an apparatus for simulating a logical qubit according to an embodiment of the present disclosure includes one or more processors and memory for storing at least one program executed by the one or more processors, and the at least one program receives a logical qubit operation for simulating a logical qubit, performs a logical qubit operation for calculating a logical value, a probability amplitude, and the number of state vectors using a logical qubit behavior model, and stores a result of the logical qubit operation for the logical value, the probability amplitude, and the number of state vectors.

Here, the logical qubit behavior model may include a logical qubit state representation model that represents a state of a logical qubit from the logical qubit operation using a logical value at a logical qubit level, a probability amplitude at a physical qubit level, and the number of state vectors at the physical qubit level.

Here, the logical qubit behavior model may represent a state of a logical qubit |0> as a combination of a logical value |0>, probability amplitude 0 for the logical value |0>, and the number of state vectors constituting the logical value |0>.

Here, the logical qubit behavior model may represent an arbitrary state of a logical qubit as a combination of logical values |0> and |1> at the logical qubit level, probability amplitude 0 at the physical qubit level for the logical value |0>, probability amplitude 1 at the physical qubit level for the logical value |1>, and the number of state vectors at the physical qubit level that constitute the logical values |0> and |1>.

Here, the logical qubit behavior model may represent a state of a tensor product of multiple logical qubits as a combination of multiple logical values from |00 . . . 0> to |11 . . . 1>, multiple probability amplitudes from probability amplitude 00 . . . 0 to probability amplitude 11 . . . 1, and the number of state vectors constituting the logical values.

Here, the state of the tensor product of the multiple logical qubits may be used to perform a Z-boundary merge operation, a Z-boundary split operation, an X-boundary merge operation, and an X-boundary split operation, which are logical qubit operations for two or more logical qubits.

Here, the logical qubit behavior model may include a logical qubit operation model that calculates the logical value, the probability amplitude, and the number of state vectors using an initialization operation, a state injection operation, an X operation, a Z operation, an H operation, an X-boundary merge operation, an X-boundary split operation, a Z-boundary merge operation, and a Z-boundary split operation.

Here, the X operation may exchange a value of probability amplitude 0 and a value of probability amplitude 1 in a single logical qubit, and the number of state vectors at the physical qubit level may remain unchanged at a logical value |0> and a logical value |1>.

Here, the Z operation may multiply −1 by a value of probability amplitude 1 in a single logical qubit, and the number of state vectors at the physical qubit level may remain unchanged at a logical value |0> and a logical value |1>.

Here, the H operation may calculate a probability amplitude at a logical value |0> after the H operation by dividing a result of adding a value of probability amplitude 0 and a value of probability amplitude 1 by \sqrt{2} and calculate a probability amplitude at a logical value |1> after the H operation by dividing a result of subtracting a value of probability amplitude 1 from a value of probability amplitude 0 by \sqrt{2}.

Here, the Z-boundary merge operation may calculate probability amplitudes 00, 01, 10, and 11 for logical values |00>, |01>, |10>, and |11> using a joint measurement value, which is a product of measurement values of X stabilizers that are newly added when a merge operation is performed on two logical qubits, together with the values of the probability amplitudes 00, 01, 10, and 11 and normalize the probability amplitudes 00, 01, 10, and 11.

Here, the Z-boundary split operation may calculate probability amplitudes 00, 01, 10, and 11 using a value derived from the number of X stabilizers used for the Z-boundary merge operation.

Here, in the X-boundary merge operation, when a joint measurement value, which is a product of measurement values of Z stabilizers, is 0, only logical values |00> and |11> are valid, logical values |01> and |10> may be deleted, and probability amplitude 00 and probability amplitude 11 may be calculated, whereas when the joint measurement value is 1, only logical values |01> and |10> are valid, logical values |00> and |11> may be deleted, and probability amplitude 01 and probability amplitude 10 may be calculated.

Here, in the X-boundary split operation, when the joint measurement value obtained in the X-boundary merge operation is 0, a probability amplitude may be calculated by multiplying a value derived from the number of Z stabilizers by probability amplitude 00 and probability amplitude 11, whereas when the joint measurement value is 1, a probability amplitude may be calculated by multiplying the value derived from the number of Z stabilizers by probability amplitude 01 and probability amplitude 10.

Also, in order to accomplish the above objects, a method for simulating a logical qubit, performed by an apparatus for simulating a logical qubit, according to an embodiment of the present disclosure includes receiving a logical qubit operation for simulating a logical qubit, performing a logical qubit operation for calculating a logical value, a probability amplitude, and the number of state vectors using a logical qubit behavior model, and storing a result of the logical qubit operation for the logical value, the probability amplitude, and the number of state vectors.

Here, the logical qubit behavior model may include a logical qubit state representation model that represents a state of a logical qubit from the logical qubit operation using a logical value at a logical qubit level, a probability amplitude at a physical qubit level, and the number of state vectors at the physical qubit level.

Here, the logical qubit behavior model may represent a state of a logical qubit |0> as a combination of a logical value |0>, probability amplitude 0 for the logical value |0>, and the number of state vectors constituting the logical value |0>.

Here, the logical qubit behavior model may represent an arbitrary state of a logical qubit as a combination of logical values |0> and |1> at the logical qubit level, probability amplitude 0 at the physical qubit level for the logical value |0>, probability amplitude 1 at the physical qubit level for the logical value |1>, and the number of state vectors at the physical qubit level that constitute the logical values |0> and |1>.

Here, the logical qubit behavior model may represent a state of a tensor product of multiple logical qubits as a combination of multiple logical values from |00 . . . 0> to |11 . . . 1>, multiple probability amplitudes from probability amplitude 00 . . . 0 to probability amplitude 11 . . . 1, and the number of state vectors constituting the logical values.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a block diagram illustrating an apparatus for simulating a logical qubit according to an embodiment of the present disclosure;

FIG. 2 is a block diagram illustrating a logical qubit behavior model according to an embodiment of the present disclosure;

FIG. 3 is a view illustrating a method in which a logical qubit state representation model represents a state of a single logical qubit by simplifying the same according to an embodiment of the present disclosure;

FIG. 4 is a view illustrating a logical qubit state representation required for a |0> initialization operation of a single logical qubit in a logical qubit behavior model according to an embodiment of the present disclosure;

FIG. 5 is a view illustrating a logical qubit state representation required for a state injection operation of a single logical qubit in a logical qubit behavior model according to an embodiment of the present disclosure;

FIG. 6 is a view illustrating a state representation for a tensor product of multiple logical qubits in a logical qubit behavior model according to an embodiment of the present disclosure;

FIG. 7 is a view illustrating a process of performing a logical X operation on a single logical qubit according to an embodiment of the present disclosure;

FIG. 8 is a view illustrating a process of performing a logical Z operation on a single logical qubit according to an embodiment of the present disclosure;

FIG. 9 is a view illustrating a process of performing a logical H operation on a single logical qubit according to an embodiment of the present disclosure;

FIG. 10 is a view illustrating a process of performing a Z-boundary merge operation according to an embodiment of the present disclosure;

FIG. 11 is a view illustrating a process of performing a Z-boundary split operation according to an embodiment of the present disclosure;

FIG. 12 is a view illustrating a process of performing an X-boundary merge operation according to an embodiment of the present disclosure;

FIG. 13 is a view illustrating a process of performing an X-boundary split operation according to an embodiment of the present disclosure;

FIG. 14 is a flowchart illustrating a method for simulating a logical qubit according to an embodiment of the present disclosure; and

FIG. 15 is a view illustrating a computer system according to an embodiment of the present disclosure.

### DESCRIPTION OF THE PREFERRED EMBODIMENTS

The present disclosure will be described in detail below with reference to the accompanying drawings. Repeated descriptions and descriptions of known functions and configurations which have been deemed to unnecessarily obscure the gist of the present disclosure will be omitted below. The embodiments of the present disclosure are intended to fully describe the present disclosure to a person having ordinary knowledge in the art to which the present disclosure pertains. Accordingly, the shapes, sizes, etc. of components in the drawings may be exaggerated in order to make the description clearer.

Throughout this specification, the terms “comprises” and/or “comprising” and “includes” and/or “including” specify the presence of stated elements but do not preclude the presence or addition of one or more other elements unless otherwise specified.

Hereinafter, a preferred embodiment of the present disclosure will be described in detail with reference to the accompanying drawings.

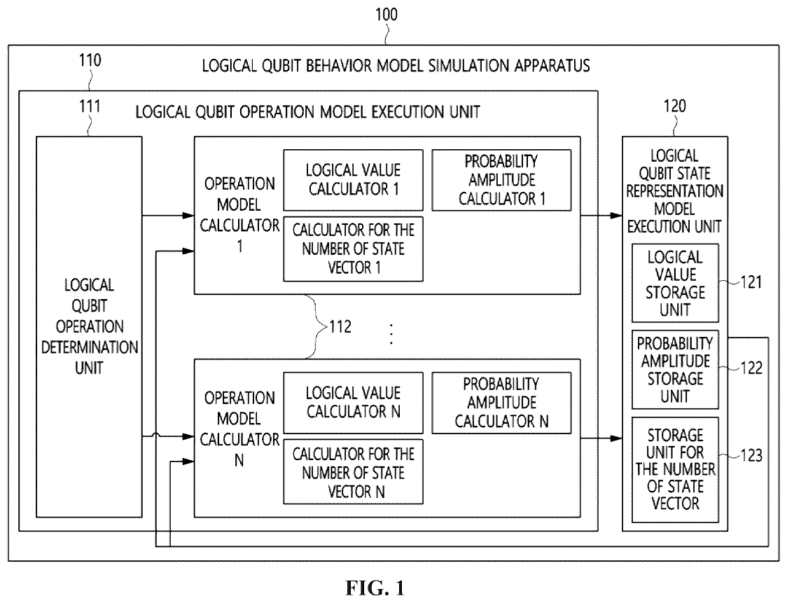

FIG. 1 is a block diagram illustrating an apparatus for simulating a logical qubit according to an embodiment of the present disclosure.

Referring to FIG. 1, the apparatus 100 for simulating a logical qubit according to an embodiment of the present disclosure may provide a logical qubit behavior model that is able to obtain an outcome after error syndrome measurement through calculation of an equation.

Here, the apparatus 100 for simulating a logical qubit does not actually perform a complex error syndrome measurement operation that is based on a physical qubit operation.

Also, the apparatus 100 for simulating a logical qubit may simulate a logical qubit based on a rotated surface code by utilizing the logical qubit behavior model.

Simulating a logical qubit based on the rotated surface code may have a low complexity of O(log d).

Here, d may correspond to the distance of the logical qubit.

The apparatus 100 for simulating a logic qubit may simulate a logical qubit with a long distance, which cannot be implemented with current quantum simulators, and may provide an execution time that is tens of millions of times faster than existing quantum simulators.

The existing quantum simulators are required to perform an error syndrome measurement operation with a complexity of O(d²) in order to simulate a logical qubit based on a rotated surface code. When this method is used, only logical qubits with a distance of 5 or less can be simulated, and the execution time also greatly increases.

The apparatus 100 for simulating a logical qubit according to an embodiment of the present disclosure may include a logical qubit operation model execution unit 110 and a logical qubit state representation model execution unit 120.

The logical qubit operation model execution unit 110 may receive a logical qubit operation for simulating a logical qubit.

Here, the logical qubit operation model execution unit 110 may calculate a logical qubit operation result merely by calculating a simple equation without performing time-consuming error syndrome measurement on the logical qubit operation.

The logical qubit operation model execution unit 110 may include a logical qubit operation determination unit 111 and multiple operation model calculators 112.

The logical qubit operation determination unit 111 may determine the received logical qubit operation and call the operation model calculator 112 corresponding to the determined logical qubit operation.

The operation model calculator 112 may include a logical value calculator, a probability amplitude calculator, and a calculator for the number of state vector.

Here, the operation model calculator 112 may perform logical qubit operations for calculating a logical value, a probability amplitude, and the number of state vectors using a logical qubit behavior model.

Here, the operation model calculator 112 may perform the logical qubit operation by calling the three calculators.

For example, when the received logical qubit operation is determined to be logical qubit operation 1, the logical qubit operation determination unit 111 may call operation model calculator 1, and the operation model calculator 1 may perform the logical qubit operation 1.

The logical qubit state representation model execution unit 120 may store results of the logical qubit operations for the logical value, the probability amplitude, and the number of state vectors.

Here, the logical qubit state representation model execution unit 120 may include a logical value storage unit 121, a probability amplitude storage unit 122, and a storage unit for the number of state vector 123.

The logical qubit state representation model execution unit 120 may store the logical qubit operation results of the logical qubit operation model execution unit 110.

The logical qubit state representation model execution unit 120 may also use the stored logical qubit state as input for the subsequent logical qubit operation.

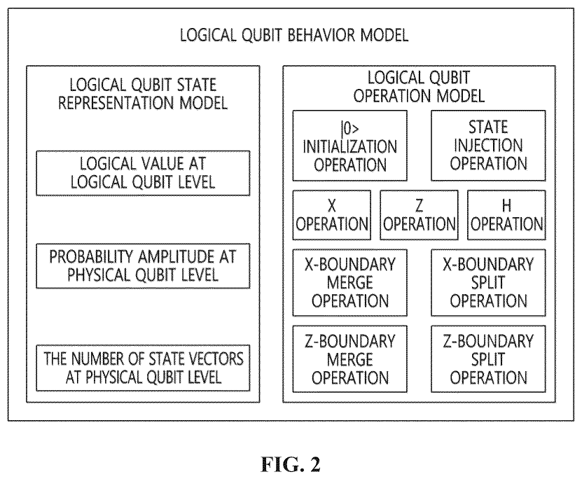

FIG. 2 is a block diagram illustrating a logical qubit behavior model according to an embodiment of the present disclosure.

Referring to FIG. 2, the logical qubit behavior model according to an embodiment of the present disclosure may correspond to a model operating at the level of mixture of logical qubits and physical qubits.

The logical qubit behavior model may not perform error syndrome measurement, which takes a long time to perform a logical qubit operation.

Here, the logical qubit behavior model may analyze a state change before and after a logical qubit operation is performed.

Here, the logical qubit behavior model may directly calculate the logical qubit operation.

The logical qubit behavior model may include a logical qubit state representation model and a logical qubit operation model.

The logical qubit state representation model may represent a state of a logical qubit using a logical value at a logical qubit level, a probability amplitude at a physical qubit level, and the number of state vectors at the physical qubit level.

The state vector configured with a physical qubit is abstracted and represented as a logical value, and the probability amplitude and the number of state vectors may be calculated at the physical qubit level.

The content of the logical qubit state representation model may be processed in the logical qubit state representation model execution unit 120.

The logical qubit operation model may perform a logical qubit operation by calculating the logical value, the probability amplitude, and the number of state vectors through equations.

The logical qubit operations may include a |0> initialization operation, a state injection operation, an X operation, a Z operation, an H operation, a Z-boundary merge operation, a Z-boundary split operation, an X-boundary merge operation, and an X-boundary split operation.

The content of the logical qubit operation model may be processed in the logical qubit operation model execution unit 110.

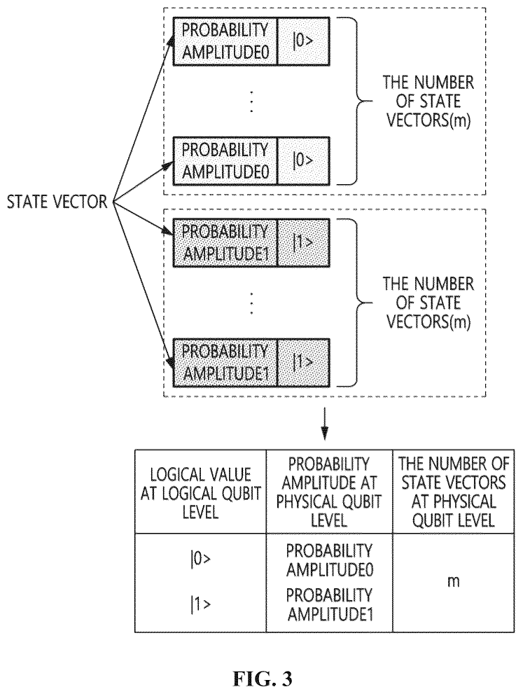

FIG. 3 is a view illustrating a method in which a logical qubit state representation model according to an embodiment of the present disclosure represents a state of a single logical qubit by simplifying the same.

A logical qubit may be configured with a combination of multiple physical qubits.

Here, assuming that a single logical qubit is configured with N physical qubits, the N physical qubits may be in a state of superposition, thereby generating 2N state vectors.

Also, the 2^{N} state vectors may have their probability amplitudes from probability amplitude 00 . . . 000 to probability amplitude 11 . . . 111. Existing quantum simulators may represent the state of a logical qubit using all of the 2^{N} state vectors and the 2^{N} probability amplitude values.

Referring to FIG. 3, the logical qubit state representation model according to an embodiment of the present disclosure may represent a logical qubit state by simplifying the same.

In a logical qubit using a rotated surface code, only 2m (=2× m) state vectors, among the 2^{N} state vectors, have valid probability amplitudes, and the remaining state vectors have a probability amplitude of 0 and are invalid.

The logical qubit state representation model may use only the valid 2m state vectors.

Also, the 2m state vectors are configured with combinations of different physical qubit values at a physical qubit level, but may be represented by being abstracted to be a logical value state |0> or |1> at a logical qubit level.

That is, among the 2m state vectors, m state vectors may be abstracted to be a logical value |0>, and the remaining m state vectors may be abstracted to be a logical value |1>.

The logical qubit state representation model may use the two logical-qubit-level logical values, |0> and |1>, rather than 2m physical-qubit-level state vectors. Also, the number of state vectors at the physical qubit level may be defined as m, which is the number of valid state vectors.

All of the m state vectors abstracted to be the same logical value may have the same probability amplitude.

All of the m state vectors abstracted to be the logical value |0> may have the same value of probability amplitude 0.

All of the m state vectors abstracted to be the logical value |1> may have the same value of probability amplitude 1.

Accordingly, the logical qubit state representation model may use only a single physical-qubit-level probability amplitude value, rather than m probability amplitudes corresponding to the same logical value.

Finally, in order to represent a state of a single logical qubit, the logical qubit state representation model may use the logical-qubit-level logical values |0> and |1>, the physical-qubit-level probability amplitude 0 for the logical value |0>, the physical-qubit-level probability amplitude 1 for the logical value |1>, and m, which is the number of state vectors at the physical level that constitute the logical values |0> and |1>.

To this end, the logical qubit state representation model may use only at least five memory repositories.

The number of memory repositories, 5, may not change even if the value of d increases.

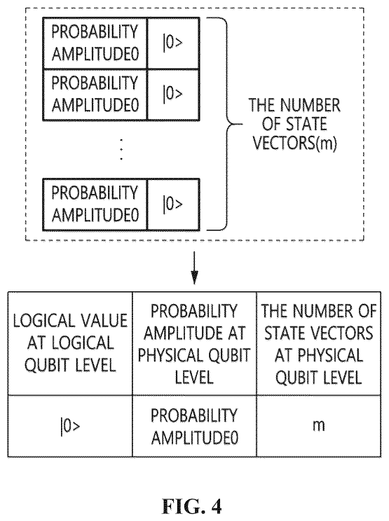

FIG. 4 is a view illustrating a logical qubit state representation required for a |0> initialization operation of a single logical qubit in a logical qubit behavior model according to an embodiment of the present disclosure.

Referring to FIG. 4, the method of applying the logical qubit behavior model to each logical qubit operation can be seen.

The state of a logical qubit |0> may be represented by being simplified as a combination of a logical value |0>, probability amplitude 0 for the logical value |0>, and m, which is the number of state vectors constituting the logical value |0>.

The method of calculating the logical value, the probability amplitude 0, and m, which is the number of state vectors, for the state of the logical qubit |0> may be represented as shown in Equation (1).

Equation (1) may be used for the |0> initialization operation of a logical qubit.

$$\begin{matrix}{\vert 0 〉 = \frac{1}{\sqrt{m}} {\sum }_{i = 1}^{m} \vert 0 〉}_{i} \\ nx = {2}^{( {d}^{2} - 1 ) / 2} \\ m = {2}^{nx}\end{matrix} \qquad ( 1 )$$

In Equation (1), it can be seen that

$$\frac{1}{\sqrt{m}}$$

denotes the probability amplitude 0, m denotes the number of state vectors, and |0 [symbol] ᵢ denotes the logical value.

The state represented in Equation (1) represents the |0> initialization state, and it can be seen that only |0> is present as the logical value.

The number of X stabilizers included in the logical qubit, nx, may be calculated based on the distance (d) of the logical qubit.

The number of state vectors, m, may be calculated depending on nx.

Also, the probability amplitude 0 may be calculated based on the number of state vectors, m.

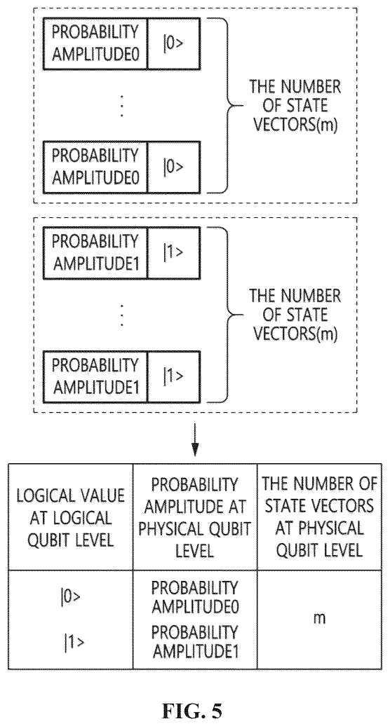

FIG. 5 is a view illustrating a logical qubit state representation required for a state injection operation of a single logical qubit in a logical qubit behavior model according to an embodiment of the present disclosure.

Referring to FIG. 5, an arbitrary state of a single physical qubit may be represented as |ψ [symbol] =α|0 [symbol] +β|1 [symbol] .

When an arbitrary state is injected into a logical qubit, the state may be represented as shown in FIG. 5 in the logical qubit behavior model.

The arbitrary state of a logical qubit may be represented by being simplified to logical values |0> and |1>, probability amplitude 0 for the logical value |0>, probability amplitude 1 for the logical value |1>, and m, which is the number of state vectors constituting the logical values |0> and |1>.

The method of calculating the logical values, the probability amplitude 0, the probability amplitude 1, and the number of state vectors, m, for the arbitrary state of the logical qubit may be represented as shown in Equation (2):

$${{\vert ψ 〉 = \frac{α}{\sqrt{m}} {\sum }_{i = 1}^{m} \vert 0 〉}_{i} + \frac{β}{\sqrt{m}} {\sum }_{i = 1}^{m} \vert 1 〉}_{i} \qquad ( 2 )$$

In Equation (2), it can be seen that

$$\frac{α}{\sqrt{m}}$$

denotes the probability amplitude 0, m denotes the number of state vectors,

$$\frac{β}{\sqrt{m}}$$

denotes the probability amplitude 1, and |0 [symbol] ᵢ and |1 [symbol] ᵢ denote the logical values.

The arbitrary quantum state may have both the logical values |0> and |1>.

The number of state vectors, m, may have the same value as in the state of the logical qubit |0> of Equation (1).

The probability amplitude 0 and the probability amplitude 1 may be calculated using m, which is the number of state vectors, and α and β, which represent an arbitrary quantum state.

Equation (2) may be used for a state injection operation of a logical qubit.

Also, the arbitrary quantum state representation may also be used for X, Z, and H operations, which are operations for a single logical qubit.

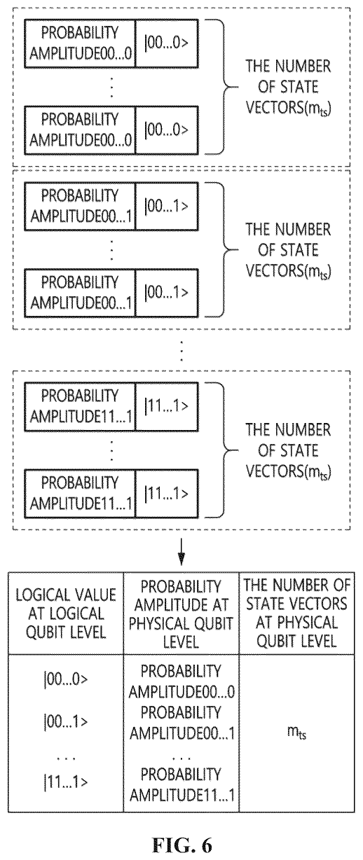

The states of two or more qubits are represented as a tensor product, and the tensor product in a logical qubit behavior model may be represented as shown in FIG. 6.

FIG. 6 is a view illustrating a state representation for a tensor product of multiple logical qubits in a logical qubit behavior model according to an embodiment of the present disclosure.

Referring to FIG. 6, it can be seen that, when the state of a tensor product of N physical qubits is implemented as a logical qubit in the logical qubit behavior model, the representation is illustrated.

The state of the tensor product of N physical qubits may be represented as |ψ₁ψ₂ . . . ψ_{N} [symbol] =C₁|00 . . . 0 [symbol] +C₂|00 . . . 1 [symbol] + . . . +C₂_{^{N}}|11 . . . 1 [symbol] .

When N logical qubits are present, the states of all of the logical qubits may be represented as a superposition of 2^{N} logical values.

Accordingly, the respective state vectors may be represented by being abstracted to be logical values from |00 . . . 0> to |11 . . . 1>.

Each of the logical values may have mₜₛ state vectors.

Also, all of the mₜₛ state vectors representing the logical value |00 . . . 0> may have the same value of probability amplitude 00 . . . 0.

Here, all of the mₜₛ state vectors representing the logical value |11 . . . 1> may have the same value of probability amplitude 11 . . . 1.

Accordingly, the state of the tensor product of the N logical qubits may be represented using 2^{N} logical values from |00 . . . 0> to |11 . . . 1>, 2^{N} probability amplitudes from probability amplitude 00 . . . 0 to probability amplitude 11 . . . 1, and mₜₛ, which is the number of state vectors constituting each of the logical values.

The method of calculating the logical values, the probability amplitudes, and the number of state vectors for the state of a tensor product of logical qubits may be represented as shown in Equation (3):

$${{{\vert {ψ}_{1} {ψ}_{2} ⋯ {ψ}_{N} 〉 = \frac{{C}_{1}}{\sqrt{{m}_{ts}}} {\sum }_{i = 1}^{{m}_{ts}} \vert 00 …0 〉}_{i} + \frac{{C}_{2}}{\sqrt{{m}_{ts}}} {\sum }_{i = 1}^{{m}_{ts}} \vert 00 …1 〉}_{i} + ⋯ + \frac{{C}_{{2}^{N}}}{\sqrt{{m}_{ts}}} {\sum }_{i = 1}^{{m}_{ts}} \vert 11 …1 〉}_{i} \qquad ( 3 )$$

In Equation (3), it can be seen that

$$\frac{{C}_{1}}{\sqrt{{m}_{ts}}}$$

denotes the probability amplitude 00 . . . 0, mₜₛ denotes the number of state vectors,

$$\frac{{C}_{2} N}{\sqrt{{m}_{ts}}}$$

denotes the probability amplitude 11 . . . 1, and |00 . . . 0 [symbol] ; and |11 . . . 1 [symbol] ᵢ denote the logical values.

Because the state of the entire logical qubit is represented as a superposition of 2^{N} logical values, the logical values may have values from |00 . . . 0> to |11 . . . 1>.

The number of state vectors, mₜₛ, may be calculated as m₁×m₂× . . . ×m_{N}, which is the product of the numbers of state vectors of all of the logical qubits.

m₁ and m_{N} are the numbers of state vectors for the first and N-th logical qubits.

The values of the probability amplitude 00 . . . 0 to the probability amplitude 11 . . . 1 may be calculated using mₜₛ, which is the number of state vectors, and C₁ to C₂^{N}, which are the probability amplitudes for the state of the tensor product of the physical qubits.

The representation for the state of a tensor product of logical qubits may be used to perform a Z-boundary merge operation, a Z-boundary split operation, an X-boundary merge operation, and an X-boundary split operation, which are logical qubit operations for two or more logical qubits.

Also, the representation may be used to represent the state of multiple logical qubits.

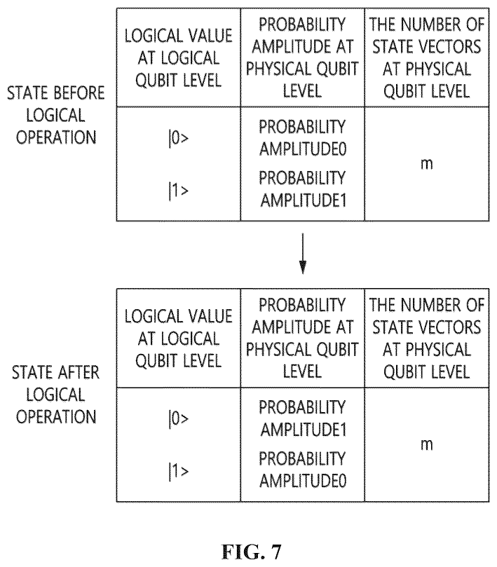

FIG. 7 is a view illustrating a process of performing a logical X operation on a single logical qubit according to an embodiment of the present disclosure.

Referring to FIG. 7, it can be seen that the value of probability amplitude 0 and the value of probability amplitude 1 are exchanged and that the number of state vectors, m, and the logical value |0> and the logical value |1> remain unchanged.

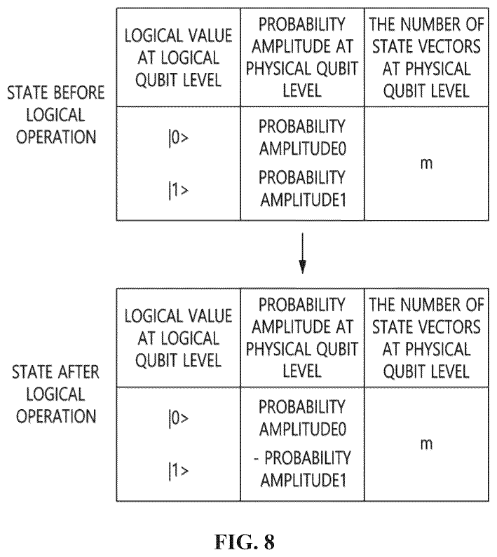

FIG. 8 is a view illustrating a process of performing a logical Z operation on a single logical qubit according to an embodiment of the present disclosure.

Referring to FIG. 8, it can be seen that the value of probability amplitude 1 is multiplied by −1 and that the number of state vectors, m, and the logical value |0> and the logical value |1> remain unchanged.

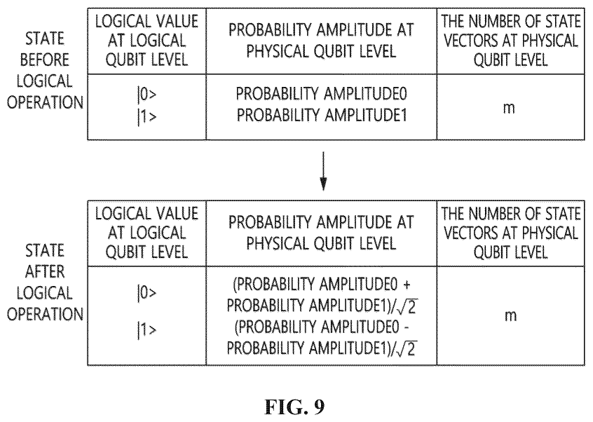

FIG. 9 is a view illustrating a process of performing a logical H operation on a single logical qubit according to an embodiment of the present disclosure.

Referring to FIG. 9, the probability amplitudes for the logical values |0> and |1> after performing a logical H operation may be calculated by dividing a result of adding the value of probability amplitude 0 and the value of probability amplitude 1 or a result of subtracting the value of probability amplitude 1 from the value of probability amplitude 0 by \sqrt{2}. It can be seen that the number of state vectors, m, the logical value |0>, and the logical value |1> remain unchanged.

Logical CNOT, S, and T operations may be performed through a combination of a Z-boundary merge operation, a Z-boundary split operation, an X-boundary merge operation, and an X-boundary split operation.

Therefore, a method of performing merge and split operations in a logical qubit behavior model is proposed.

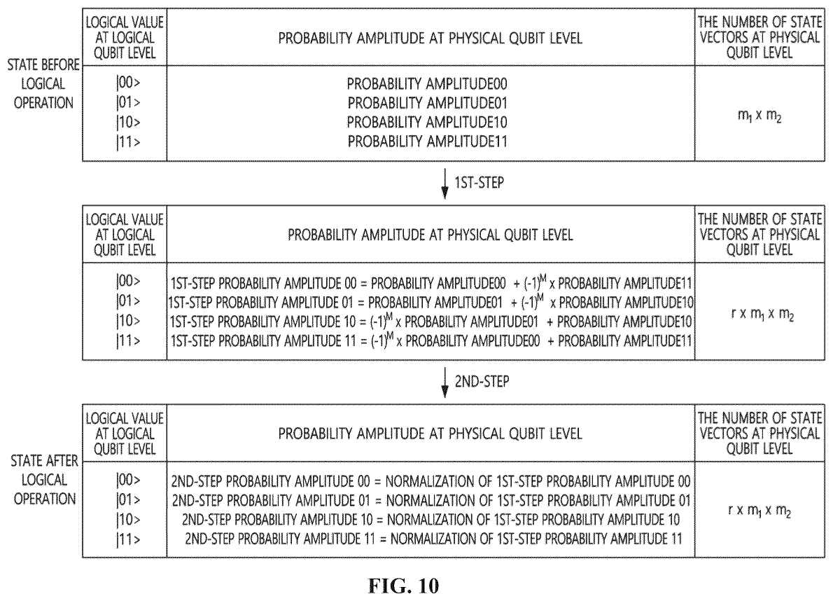

FIG. 10 is a view illustrating a process of performing a Z-boundary merge operation according to an embodiment of the present disclosure.

Referring to FIG. 10, it can be seen that a process of calculating a logical value, a probability amplitude, and the number of state vectors in a Z-boundary merge operation is illustrated.

The state of a tensor product of two logical qubits before the Z-boundary merge operation may be represented using probability amplitude 00, probability amplitude 01, probability amplitude 10, probability amplitude 11, the logical values |00>, |01>, |10>, and |11>, and the number of state vectors, m₁×m₂.

The method of performing the Z-boundary merge operation may be processed through two steps. When each step is performed, the four logical values may remain unchanged.

At the first step, the first-step probability amplitude 00 to the first-step probability amplitude 11 for the logical values |00>, |01>, |10>, and |11> may be calculated using a joint measurement value, M, and the values of the probability amplitude 00 to the probability amplitude 11.

The joint measurement value, M, is the product of the measurement values of X stabilizers that are newly added when a merge operation is performed on the two logical qubits.

The number of state vectors, r×m₁×m₂, may be calculated by multiplying the product of m₁ and m₂, which are the numbers of state vectors of the two logical qubits to be merged, by the value of r(=2^{(d-1)/2}), which is derived from the number of X stabilizers added during the Z-boundary merge operation.

At the second step, the second-step probability amplitude 00 to the second-step probability amplitude 11 may be calculated by performing calculation for normalizing four probability amplitudes from the first-step probability amplitude 00 to the first-step probability amplitude 11, as shown in Equation (4).

Because r is greater than 1 in the Z-boundary merge operation, the values of the probability amplitudes for the logical values from |00> to |11> after the Z-boundary merge operation may decrease, and the number of state vectors may increase.

$$2 nd - step probability amplitude 00 = \frac{1 st - step probability amplitude 00}{\sqrt{2 {Krm}_{1} {m}_{2}}}$$

$$2 nd - step probability amplitude 01 = \frac{1 st - step probability amplitude 01}{\sqrt{2 {Krm}_{1} {m}_{2}}}$$

$$2 nd - step probability amplitude 10 = \frac{1 st - step probability amplitude 10}{\sqrt{2 {Krm}_{1} {m}_{2}}}$$

$$2 nd - step probability amplitude 11 = \frac{1 st - step probability amplitude 11}{\sqrt{2 {Krm}_{1} {m}_{2}}}$$

$$K = {\vert probability amplitude 00 + {( - 1 )}^{M} \times probability amplitude 11 \vert}^{2} + {\vert probability amplitude 01 + {( - 1 )}^{M} \times probability amplitude 10 \vert}^{2}$$

$$r = {2}^{( d - 1 ) / 2} \qquad ( 4 )$$

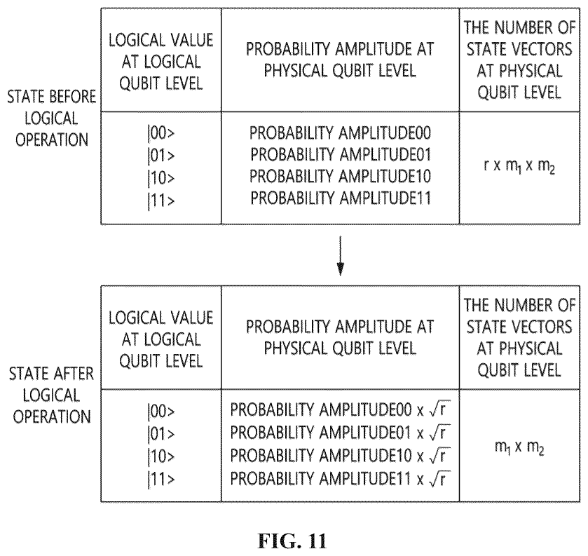

FIG. 11 is a view illustrating a process of performing a Z-boundary split operation according to an embodiment of the present disclosure.

Referring to FIG. 11, it can be seen that a process of calculating a logical value, a probability amplitude, and the number of state vectors in a Z-boundary split operation is illustrated.

The state before the Z-boundary split operation may be represented using the logical values |00>, |01>, |10>, and |11>, probability amplitude 00, probability amplitude 01, probability amplitude 10, probability amplitude 11, and the number of state vectors, r ×m₁×m².

In the state after performing the Z-boundary split operation, the four logical values may remain unchanged.

The four probability amplitudes may be calculated by multiplying \sqrt{r}, which was used for the Z-boundary merge operation, by the probability amplitudes before the operation.

Also, the number of state vectors may be changed from r×m₁×m₂ to m₁×m₂.

Because r is greater than 1 in the Z-boundary split operation, the values of the probability amplitudes for the logical values from |00> to |11> after the Z-boundary split operation may increase, and the number of state vectors may decrease.

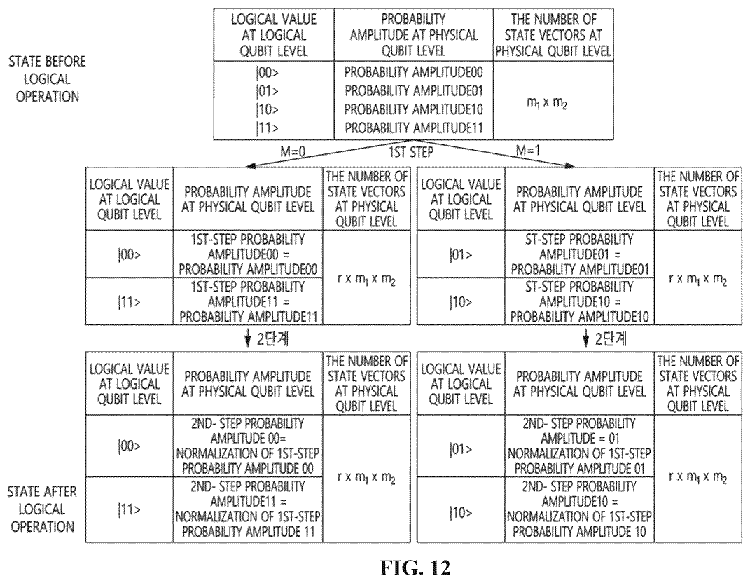

FIG. 12 is a view illustrating a process of performing an X-boundary merge operation according to an embodiment of the present disclosure.

Referring to FIG. 12. It can be seen that a process of calculating a logical value, a probability amplitude, and the number of state vectors in an X-boundary merge operation is illustrated.

The state of a tensor product of two logical qubits before the X-boundary merge operation may be represented using the logical values |00>, |01>, |10>, and |11>, probability amplitude 00, probability amplitude 01, probability amplitude 10, probability amplitude 11, and the number of state vectors, m₁×m₂.

The method of performing the X-boundary merge operation may be processed through two steps, and the method may be classified into two results depending on a joint measurement value, M, which is the product of the measurement values of Z stabilizer added during the operation.

When M is 0, only the logical values |00> and |11> are valid at the first step, and the logical values |01> and |10> may be deleted.

Probability amplitude 00 and probability amplitude 11 may be used, without change, as the first-step probability amplitude 00 and the first-step probability amplitude 11 for the logical values |00> and |11>.

At the second step, the second-step probability amplitude 00 and the second-step probability amplitude 11 may be calculated by performing calculation for normalizing the first-step probability amplitude 00 and the first-step probability amplitude 11 as shown in Equation (5):

$$M = 0$$

$$2 nd - step probabiliy amplitude 00 = 1 st - step probability amplitude 00 \times \sqrt{\frac{2}{{Krm}_{1} {m}_{2}}}$$

$$2 nd - step probabiliy amplitude 11 = 1 st - step probability amplitude 11 \times \sqrt{\frac{2}{{Krm}_{1} {m}_{2}}}$$

$$K = {\vert probability amplitude 00 + probability amplitude 11 \vert}^{2} + {\vert - probability amplitude 00 + probability amplitude 11 \vert}^{2}$$

$$r = {( \frac{1}{2} )}^{( d - 1 ) / 2} \qquad ( 5 )$$

When M is 1, only the logical values |01> and |10> are valid at the first step, and the logical values |00> and |11> may be deleted. Probability amplitude 01 and probability amplitude 10 may be used, without change, as the first-step probability amplitude 01 and the first-step probability amplitude 10 for the logical values |01> and |10>.

At the second step, the second-step probability amplitude 01 and the second-step probability amplitude 10 may be calculated by performing calculation for normalizing the first-step probability amplitude 01 and the first-step probability amplitude 10 as shown in Equation (6):

$$M = 1$$

$$2 nd - step probabiliy amplitude 01 = 1 st - step probability amplitude 01 \times \sqrt{\frac{2}{{Krm}_{1} {m}_{2}}}$$

$$2 nd - step probabiliy amplitude 10 = 1 st - step probability amplitude 10 \times \sqrt{\frac{2}{{Krm}_{1} {m}_{2}}}$$

$$K = {\vert probability amplitude 01 + probability amplitude 10 \vert}^{2} + {\vert - probability amplitude 01 + probability amplitude 10 \vert}^{2}$$

$$r = {( \frac{1}{2} )}^{( d - 1 ) / 2} \qquad ( 6 )$$

The number of state vectors may be calculated using the same method in both cases where M is 0 and 1. The number of state vectors, r×m₁×m₂, may be calculated by multiplying the product of m₁ and m₂, which are the numbers of state vectors of the two logical qubits to be merged, by the value of r (=(1/2)^{(d+1)/2}) derived from the number of Z stabilizers that are deleted during the X-boundary merge operation.

Because r is less than 1 in the X-boundary merge operation, the values of the probability amplitudes for the logical values from |00> to |11> after the X-boundary merge operation may increase, and the number of state vectors may decrease.

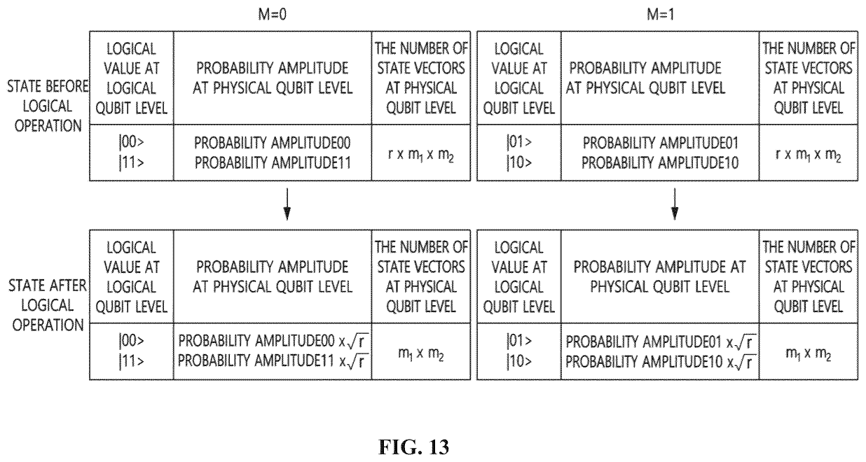

FIG. 13 is a view illustrating a process of performing an X-boundary split operation according to an embodiment of the present disclosure.

Referring to FIG. 13, it can be seen that a process of calculating a logical value, a probability amplitude, and the number of state vectors in an X-boundary split operation is illustrated.

Depending on the value of M obtained in the X-boundary merge operation, the X-boundary split operation may also be classified into two cases.

When M is 0, the state before the X-boundary split operation may be represented using the logical values |00> and |11>, probability amplitude 00, probability amplitude 11, and the number of state vectors, r×m₁×m₂.

When the X-boundary split operation is performed, two probability amplitudes after the X-boundary split operation may be calculated by multiplying \sqrt{r}, which was used for the X-boundary merge operation, by the probability amplitude 00 and the probability amplitude 11.

When Mis 1, the state before the X-boundary split operation may be represented using the logical values |01> and |10>, probability amplitude 01, probability amplitude 10, and the number of state vectors, r×m₁×m₂.

When the X-boundary split operation is performed, two probability amplitudes after the X-boundary split operation may be calculated by multiplying \sqrt{r}, which was used for the X-boundary merge operation, by the probability amplitude 01 and the probability amplitude 10.

The number of state vectors may be calculated using the same method in both cases where M is 0 and 1.

The number of state vectors may be changed from r×m₁×m₂ to m₁×m₂.

Because r is less than 1 in the X-boundary split operation, the values of the probability amplitudes for the logical values from |00> to |11> after the X-boundary split operation may decrease, and the number of state vectors may increase.

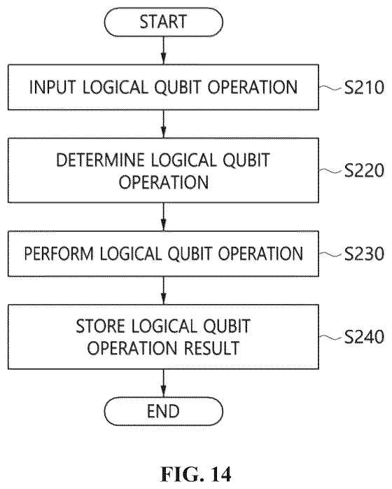

FIG. 14 is a flowchart illustrating a method for simulating a logical qubit according to an embodiment of the present disclosure.

Referring to FIG. 14, in the method for simulating a logical qubit according to an embodiment of the present disclosure, first, a logical qubit operation may be received at step S210.

That is, at step S210, a logical qubit operation for simulating a logical qubit may be received.

Also, in the method for simulating a logical qubit according to an embodiment of the present disclosure, the logical qubit operation may be determined at step S220.

That is, at step S220, the received logical qubit operation may be determined, and an operation model calculator 112 corresponding to the determined logical qubit operation may be called.

The operation model calculator 112 may include a logical value calculator, a probability amplitude calculator, and a calculator for the number of state vector.

Also, in the method for simulating a logical qubit according to an embodiment of the present disclosure, a logical qubit operation may be performed at step S230.

That is, at step S230, a logical qubit operation for calculating a logical value, a probability amplitude, and the number of state vectors may be performed using a logical qubit behavior model.

For example, at step S230, operation model calculator 1 may be called when the received logical qubit operation is determined to be logical qubit operation 1, and the operation model calculator 1 may perform the logical qubit operation 1.

Also, in the method for simulating a logical qubit according to an embodiment of the present disclosure, a result of the logical qubit operation may be stored at step S240.

That is, at step S240, the results of the logical qubit operations for calculating the logical value, calculating the probability amplitude, and calculating the number of state vectors may be stored.

The stored logical qubit state may also be used as input for the subsequent logical qubit operation.

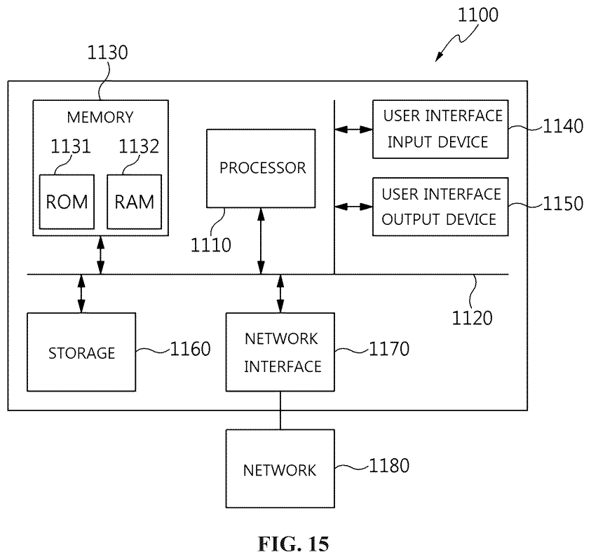

FIG. 15 is a view illustrating a computer system according to an embodiment of the present disclosure.

Referring to FIG. 15, the apparatus 100 for simulating a logical qubit according to an embodiment of the present disclosure may be implemented in a computer system 1100 including a computer-readable recording medium. As illustrated in FIG. 15, the computer system 1100 may include one or more processors 1110, memory 1130, a user-interface input device 1140, a user-interface output device 1150, and storage 1160, which communicate with each other via a bus 1120. Also, the computer system 1100 may further include a network interface 1170 connected to a network 1180. The processor 1110 may be a central processing unit or a semiconductor device for executing processing instructions stored in the memory 1130 or the storage 1160. The memory 1130 and the storage 1160 may be any of various types of volatile or nonvolatile storage media. For example, the memory may include ROM 1131 or RAM 1132.

The apparatus for simulating a logical qubit according to an embodiment of the present disclosure includes one or more processors 1110 and memory 1130 for storing at least one program executed by the one or more processors 1110, and the at least one program receives a logical qubit operation for simulating a logical qubit, performs a logical qubit operation for calculating a logical value, a probability amplitude, and the number of state vectors using a logical qubit behavior model, and stores a result of the logical qubit operation for the logical value, the probability amplitude, and the number of state vectors.

Here, the logical qubit behavior model may include a logical qubit state representation model that represents the state of the logical qubit from the logical qubit operation using a logical value at a logical qubit level, a probability amplitude at a physical qubit level, and the number of state vectors at the physical qubit level.

Here, the logical qubit behavior model may represent the state of a logical qubit |0> as a combination of a logical value |0>, probability amplitude 0 for the logical value |0>, and the number of state vectors constituting the logical value |0>.

Here, the logical qubit behavior model may represent an arbitrary state of a logical qubit as a combination of logical values |0> and |1> at the logical qubit level, probability amplitude 0 at the physical qubit level for the logical value |0>, probability amplitude 1 at the physical qubit level for the logical value |1>, and the number of state vectors at the physical qubit level that constitute the logical values |0> and |1>.

Here, the logical qubit behavior model may represent the state of a tensor product of multiple logical qubits as a combination of multiple logical values from |00 . . . 0> to |11 . . . 1>, multiple probability amplitudes from probability amplitude 00 . . . 0 to probability amplitude 11 . . . 1, and the number of state vectors constituting the logical values.

Here, the state of the tensor product of the multiple logical qubits may be used to perform a Z-boundary merge operation, a Z-boundary split operation, an X-boundary merge operation, and an X-boundary split operation, which are logical qubit operations for two or more logical qubits.

Here, the logical qubit behavior model may include a logical qubit operation model that calculates the logical value, the probability amplitude, and the number of state vectors using an initialization operation, a state injection operation, an X operation, a Z operation, an H operation, an X-boundary merge operation, an X-boundary split operation, a Z-boundary merge operation, and a Z-boundary split operation.

Here, the X operation exchanges the value of probability amplitude 0 and the value of probability amplitude 1 in a single logical qubit, and the number of state vectors at the physical qubit level may remain unchanged at the logical value |0> and the logical value |1>.

Here, the Z operation multiplies −1 by the value of probability amplitude 1 in a single logical value, and the number of state vectors at the physical qubit level may remain unchanged at the logical value |0> and the logical value |1>.

Here, the H operation calculates a probability amplitude at the logical value |0> after the H operation by dividing a result of adding the value of probability amplitude 0 and the value of probability amplitude 1 by \sqrt{2} and calculates a probability amplitude at the logical value |1> after the H operation by dividing a result of subtracting the value of probability amplitude 1 from the value of probability amplitude 0 by \sqrt{2}.

Here, the Z-boundary merge operation may calculate probability amplitudes 00, 01, 10, and 11 for the logical values |00>, |01>, |10>, and |11> using a joint measurement value, which is the product of the measurement values of X stabilizers that are newly added when a merge operation is performed on two logical qubits, and the values of the probability amplitudes 00, 01, 10, and 11 and may normalize the probability amplitudes 00, 01, 10, and 11.

Here, the Z-boundary split operation may calculate probability amplitudes 00, 01, 10, and 11 using a value derived from the number of X stabilizers used for the Z-boundary merge operation.

Here, in the X-boundary merge operation, when a joint measurement value, which is the product of the measurement values of Z stabilizers, is 0, only the logical values |00> and |11> are valid, the logical values |01> and |10> are deleted, and probability amplitude 00 and probability amplitude 11 may be calculated, whereas when the joint measurement value is 1, only the logical values |01> and |10> are valid, the logical values |00> and |11> are deleted, and probability amplitude 01 and probability amplitude 10 may be calculated.

Here, in the X-boundary split operation, when the joint measurement value derived from the X-boundary merge operation is 0, a probability amplitude may be calculated by multiplying a value derived from the number of Z stabilizers by probability amplitude 00 and probability amplitude 11, whereas when the joint measurement value is 1, a probability amplitude may be calculated by multiplying the value derived from the number of Z stabilizers by probability amplitude 01 and probability amplitude 10.

The present disclosure may enable simulation of logical qubit operations of all distances, which cannot be performed in existing quantum simulators.

Also, the present disclosure may provide a faster performance time than existing quantum simulators.

As described above, the apparatus and method for simulating a logical qubit according to the present disclosure are not limitedly applied to the configurations and operations of the above-described embodiments, but all or some of the embodiments may be selectively combined and configured, so the embodiments may be modified in various ways.

What is claimed is:

1. An apparatus for simulating a logical qubit, comprising:
one or more processors; and
memory for storing at least one program executed by the one or more processors,
wherein the at least one program
receives a logical qubit operation for simulating a logical qubit,
performs a logical qubit operation for calculating a logical value, a probability amplitude, and the number of state vectors using a logical qubit behavior model, and
stores a result of the logical qubit operation for the logical value, the probability amplitude, and the number of state vectors.

2. The apparatus of claim 1, wherein the logical qubit behavior model includes a logical qubit state representation model that represents a state of a logical qubit from the logical qubit operation using a logical value at a logical qubit level, a probability amplitude at a physical qubit level, and the number of state vectors at the physical qubit level.

3. The apparatus of claim 2, wherein the logical qubit behavior model represents a state of a logical qubit |0> as a combination of a logical value |0>, probability amplitude 0 for the logical value |0>, and the number of state vectors constituting the logical value |0>.

4. The apparatus of claim 2, wherein the logical qubit behavior model represents an arbitrary state of a logical qubit as a combination of logical values |0> and |1> at the logical qubit level, probability amplitude 0 at the physical qubit level for the logical value |0>, probability amplitude 1 at the physical qubit level for the logical value |1>, and the number of state vectors at the physical qubit level that constitute the logical values |0> and |1>.

5. The apparatus of claim 2, wherein the logical qubit behavior model represents a state of a tensor product of multiple logical qubits as a combination of multiple logical values from |00 . . . 0> to |11 . . . 1>, multiple probability amplitudes from probability amplitude 00 . . . 0 to probability amplitude 11 . . . 1, and the number of state vectors constituting the logical values.

6. The apparatus of claim 5, wherein the state of the tensor product of the multiple logical qubits is used to perform a Z-boundary merge operation, a Z-boundary split operation, an X-boundary merge operation, and an X-boundary split operation, which are logical qubit operations for two or more logical qubits.

7. The apparatus of claim 2, wherein the logical qubit behavior model includes a logical qubit operation model that calculates the logical value, the probability amplitude, and the number of state vectors using an initialization operation, a state injection operation, an X operation, a Z operation, an H operation, an X-boundary merge operation, an X-boundary split operation, a Z-boundary merge operation, and a Z-boundary split operation.

8. The apparatus of claim 7, wherein the X operation exchanges a values of probability amplitude 0 and a value of probability amplitude 1 in a single logical qubit, and the number of state vectors at the physical qubit level remains unchanged at a logical value |0> and a logical value |1>.

9. The apparatus of claim 7, wherein the Z operation multiplies-1 by a value of probability amplitude 1 in a single logical qubit, and the number of state vectors at the physical qubit level remains unchanged at a logical value |0> and a logical value |1>.

10. The apparatus of claim 7, wherein the H operation
calculates a probability amplitude at a logical value |0> after the H operation by dividing a result of adding a value of probability amplitude 0 and a value of probability amplitude 1 by \sqrt{2}, and
calculates a probability amplitude at a logical value |1> after the H operation by dividing a result of subtracting a value of probability amplitude 1 from a value of probability amplitude 0 by \sqrt{2}.

11. The apparatus of claim 7, wherein the Z-boundary merge operation calculates probability amplitudes 00, 01, 10, and 11 for logical values |00>, |01>, |10>, and |11> using a joint measurement value, which is a product of measurement values of X stabilizers that are newly added when a merge operation is performed on two logical qubits, and values of the probability amplitudes 00, 01, 10, and 11 and normalizes the probability amplitudes 00, 01, 10, and 11.

12. The apparatus of claim 11, wherein the Z-boundary split operation calculates probability amplitudes 00, 01, 10, and 11 using a value derived from the number of X stabilizers used for the Z-boundary merge operation.

13. The apparatus of claim 7, wherein in the X-boundary merge operation,
when a joint measurement value, which is a product of measurement values of Z stabilizers, is 0, only logical values |00> and |11> are valid, logical values |01> and |10> are deleted, and probability amplitude 00 and probability amplitude 11 are calculated, and
when the joint measurement value is 1, only logical values |01> and |10> are valid, logical values |00> and |11> are deleted, and probability amplitude 01 and probability amplitude 10 are calculated.

14. The apparatus of claim 13, wherein in the X-boundary split operation,
when the joint measurement value obtained in the X-boundary merge operation is 0, a probability amplitude is calculated by multiplying a value derived from the number of Z stabilizers by probability amplitude 00 and probability amplitude 11, and
when the joint measurement value is 1, a probability amplitude is calculated by multiplying the value derived from the number of Z stabilizers by probability amplitude 01 and probability amplitude 10.

15. A method for simulating a logical qubit, performed by an apparatus for simulating a logical qubit, comprising:
receiving a logical qubit operation for simulating a logical qubit;
performing a logical qubit operation for calculating a logical value, a probability amplitude, and the number of state vectors using a logical qubit behavior model; and
storing a result of the logical qubit operation for the logical value, the probability amplitude, and the number of state vectors.

16. The method of claim 15, wherein the logical qubit behavior model includes a logical qubit state representation model that represents a state of a logical qubit from the logical qubit operation using a logical value at a logical qubit level, a probability amplitude at a physical qubit level, and the number of state vectors at the physical qubit level.

17. The method of claim 16, wherein the logical qubit behavior model represents a state of a logical qubit |0> as a combination of a logical value |0>, probability amplitude 0 for the logical value |0>, and the number of state vectors constituting the logical value |0>.

18. The method of claim 16, wherein the logical qubit behavior model represents an arbitrary state of a logical qubit as a combination of logical values |0> and |1> at the logical qubit level, probability amplitude 0 at the physical qubit level for the logical value |0>, probability amplitude 1 at the physical qubit level for the logical value |1>, and the number of state vectors at the physical qubit level that constitute the logical values |0> and |1>.

19. The method of claim 16, wherein the logical qubit behavior model represents a state of a tensor product of multiple logical qubits as a combination of multiple logical values from |00 . . . 0> to |11 . . . 1>, multiple probability amplitudes from probability amplitude 00 . . . 0 to probability amplitude 11 . . . 1, and the number of state vectors constituting the logical values.

20. The method of claim 16, wherein the logical qubit behavior model includes a logical qubit operation model that calculates the logical value, the probability amplitude, and the number of state vectors using an initialization operation, a state injection operation, an X operation, a Z operation, an H operation, an X-boundary merge operation, an X-boundary split operation, a Z-boundary merge operation, and a Z-boundary split operation.
